(19) United States
(12) Patent Application Publication
(10) Pub. No.: US 2011/0070530 A1
(43) Pub. Date: Mar. 24, 2011

(54) FUEL CELL

(75) Inventor: Ken Omersa, Hertfordshire (GB)

(73) Assignee: OMNAGEN LIMITED, Hertfordshire (GB)

(21) Appl. No.: 12/955,263

(22) Filed: Nov. 29, 2010

Related U.S. Application Data
(63) Continuation of application No. 12/346,014, filed on Dec. 30, 2008.
Application No. 12/346,014 is a division of application No. 10/719,579, filed on Nov. 21, 2003, now abandoned.

(30) Foreign Application Priority Data
Nov. 21, 2002 (GB) GB0227180.7

(51) Int. Cl. H01M 4/02

(52) U.S. Cl. 429/532

(57) ABSTRACT

A solid oxide fuel cell including an electrode having a porous region bounded by a non-porous region. The electrode may include at least 51% titanium by weight. The electrode may be a structural member which supports one or more ceramic layers, at least one of the one or more ceramic layers being an electrolyte. The non-porous region creates a gas-tight seal which prevents direct combination of oxidant and fuel. The electrode may include at least one of: (i) other metals or metal salts, (ii) catalysts, and (iii) ceramic material within its pores for improved electrochemical efficiency.

### CROSS REFERENCE TO RELATED APPLICATIONS

This application is a continuation of U.S. patent application Ser. No. 12/346,014 filed on Dec. 30, 2008, which is a divisional of U.S. patent application Ser. No. 10/719,579 filed on Nov. 21, 2003, which claims foreign priority under 35 U.S.C. §119 of Application No. GB0227180.7 filed Nov. 21, 2002, each of which is incorporated by reference in its entirety herein.

### FIELD OF THE TECHNOLOGY

The present invention relates to fuel cells. More particularly, the invention relates to solid state fuel cells, particularly solid oxide fuel cells and protonic ceramic fuel cells.

### BACKGROUND

A fuel cell is an electrical device which generates an electric current by reaction of a fuel with an oxidant without direct combustion. In general, fuel cells consist of a pair of electrodes separated by an electrolyte. The electrolyte only allows the passage of certain ions. The selective passage of ions across the electrolyte results in a potential being generated between the two electrodes. This potential can be harnessed to do useful work, such as generating electricity in a home, or for powering a vehicle.

There are various types of fuel cells which are categorised according to the type of electrolyte they contain. A considerable amount of work has been carried out on proton exchange membrane (PEM) fuel cells, in which the electrolyte is a polymeric membrane which is selectively permeable to ions. One example of a suitable polymer is “Nafion®” which conducts protons when hydrated. PEM cells generally operate near the boiling point of water. In simplified terms, hydrogen fuel is oxidised to protons at one electrode (anode) which then cross the membrane, whilst oxygen is reduced at the other electrode (cathode). In theory, the only waste product from this reaction is water.

Because of the aggressive conditions found within operating PEM cells, the structural elements of the fuel cell must be able to withstand the potentially corrosive environment. Metal elements tend to be corrosion resistant or coated with a corrosion resistant layer. However, electrical connections must not be impeded. Steel and nickel alloys are often used in this type of application. Other metals have been used for their aqueous corrosion resistance, such as aluminium, titanium or alloys thereof, as described in U.S. Pat. Nos. 5,578,388 and 3,437,525.

In addition to PEM cells, a number of other types of fuel cells have been developed. Solid oxide fuel cells (SOFCs) are a type of fuel cell which operate at relatively high temperatures, around 850 to 1000.degree. C. SOFCs which run at lower temperatures have been proposed, for example using cerium gadolinium oxide (CGO) as electrolyte. Fuel cells using CGO may be operable at or below 600.degree. C. Because of the high temperatures, the cells are often entirely made from ceramic materials. Typically, the electrolyte is made from yttria stabilised zirconia (YSZ), the fuel electrode made from a nickel oxide/YSZ cermet, and the oxidant electrode made from a doped lanthanum manganate. Another possible electrode material is lanthanum strontium cobalt iron (lanthanum strontium cobalt ferrite (LSCF)).

There are two general structural types of SOFC; tubular cells and planar cells. Although easier to produce, the planar cells suffer from difficulties with sealing around the ceramic parts of the cell. Both the planar and tubular types of cells suffer problems relating to the brittle nature of ceramic materials. These problems are exacerbated by temperature cycling which occurs in many uses of fuel cells.

Another type of ceramic fuel cell being developed is a protonic ceramic fuel cell (PCFC) which conducts protons through the solid ceramic electrolyte.

A further problem of ceramic-based fuel cells is matching the thermal expansion coefficients of various structural elements. This is particularly a problem with metallic elements, whose thermal expansion coefficients may be quite different to those of ceramic elements. Mismatched thermal expansion coefficients can lead to catastrophic failure of structural components of the cell.

It is to be appreciated that many of these prior art fuel cells suffer from a number of disadvantages, such as the need for expensive materials, complicated manufacture, and the risk of structural failure due to the brittle nature of ceramics. Thus, there exists a need for an improved fuel cell to overcome the aforementioned shortcomings.

### SUMMARY

According to one aspect of the present invention, there is provided a solid state fuel cell comprising a non-polymeric electrolyte, the fuel cell comprising a member having a porous region, the member comprising metallic titanium or an alloy thereof.

Preferably, the fuel cell is a ceramic fuel cell. In presently preferred embodiments the fuel cell is a solid oxide fuel cell (SOFC), or a protonic ceramic fuel cell (PCFC).

In a preferred embodiment, the member further comprises a non-porous region. In certain embodiments, the porous region is bounded by the non-porous region.

In one aspect of the invention, the fuel cell has an electrode comprising the member. Preferably, the member supports an electrode. In a presently preferred embodiment, the member supports an electrolyte.

In another aspect, the member provided supports one or more ceramic layers. Preferably, at least one of the one or more ceramic layers comprises cerium gadolinium oxide (CGO), yttria stabilised zirconia (YSZ), nickel oxide/YSZ cermet, nickel oxide/CGO cermet, LSCF/CGO or doped lanthanum manganate.

In one embodiment, at least one of the one or more ceramic layers is an electrode. In certain embodiments, at least one of the one or more ceramic layers is an interface layer. Preferably, at least one of the one or more ceramic layers is an electrolyte.

In one aspect of the invention, the member is a structural member. In another aspect the fuel cell further comprises an interconnect comprising titanium or an alloy thereof. Preferably, the interconnect is in contact with a member according to the invention.

In presently preferred embodiments, the porous region of the member comprises sintered metal powder. In various other embodiments, the porous region comprises metal felt. Preferably, the porous region is formed by laser machining, electrodeposition, etching. The etching, in presently preferred embodiments is photochemical etching or electrochemical etching.

In one aspect of the invention, the member and/or the interconnect is formed by pressing. In certain preferred embodiments, the member and/or interconnect is formed by superplastic forming.

The member and/or interconnect comprise titanium or an alloy thereof. In preferred embodiments, they are at least (by weight) 100%, 98%, 85%, 76%, or 51% titanium. In preferred embodiments the member and/or the interconnect comprise non alloyed titanium or a titanium alloy. Preferably, the titanium alloy is selected from the group consisting of Ti-6Al-4V, Ti-3Al-2.5V, Ti-6AL-2Sn-4Zr-2Mo-0.08Si and Ti-15Mo-3Nb-3Al-0.2Si.

In another aspect of the invention, the member and/or interconnect comprise metal foil.

The invention also provides, in another aspects solid state fuel cells comprising non-polymeric electrolyte, and further comprising a plurality of members or interconnects, or both, each member having a porous region; the members and interconnect comprising metallic titanium or an alloy thereof.

### BRIEF DESCRIPTION OF THE DRAWINGS

The present invention is described at various places throughout the specification, by way of example, with reference to the accompanying drawings:

FIG. 1 is a schematic illustration of a preferred embodiment of a fuel cell.

FIG. 2 is a schematic perspective view of the elements of another embodiment of a fuel cell,

FIG. 3 is a schematic perspective view of the elements of an alternative embodiment of a fuel cell,

FIG. 4 is a cross-sectional view of one embodiment of an electrode substrate,

FIG. 5 is a cross-sectional view of an alternative embodiment of an electrode substrate,

FIG. 6 is a cross-sectional view of a further embodiment of an electrode substrate,

FIG. 7 is a cross-sectional view of an alternative embodiment of an electrode substrate, and

FIG. 8 is a cross-sectional view of one embodiment of a stack of fuel cells.

### DETAILED DESCRIPTION OF ILLUSTRATIVE EMBODIMENTS

### Definitions

It is to be noted that where the word titanium is used in this specification, unless otherwise stated it comprises non-alloyed titanium as well as titanium alloys.

Preferably, the term “fuel cell” means the functional components making up a working fuel cell, excluding ancillary and associated apparatus. Thus, “fuel cell” preferably means the unit comprising two electrodes separated by an electrolyte, and electrical connections and housing, excluding such “external” components such as ducting for the fuel and oxidant.

Also, the phrase “solid state fuel cell” means fuel cells that do not have a liquid electrolyte. Accordingly, solid state fuel cells include ceramic fuel cells such as solid oxide fuel cells (SOFCs) and protonic ceramic fuel cells (PCFCs). Hydrogen has been exemplified as a fuel, however, this is not intended to be any way limiting. It will instead be appreciated that numerous other fuels are suitable for use in fuel cells of the invention, for example, hydrocarbons and alcohols. In particular, hydrocarbons, such as methane, may be reformed to provide a convenient fuel, or oxidised directly. Suitable alcohols include, but are not limited to methanol and ethanol. The term “polymeric electrolyte” means an electrolyte comprising polymeric or plastics material, such as those used in PEM and/or direct methanol fuel cells.

The term “member” preferably means a functional and/or structural component of a fuel cell. More preferably, it refers to an “internal” component of a fuel cell, as defined above. A member may form part or all of an electrode, may support an electrolyte, and may support other components such as ceramic layers.

The term “interconnect” generally refers to a component that is preferably positioned between adjacent fuel cells, for example in a stack of fuel cells.

### Description of Preferred Embodiments

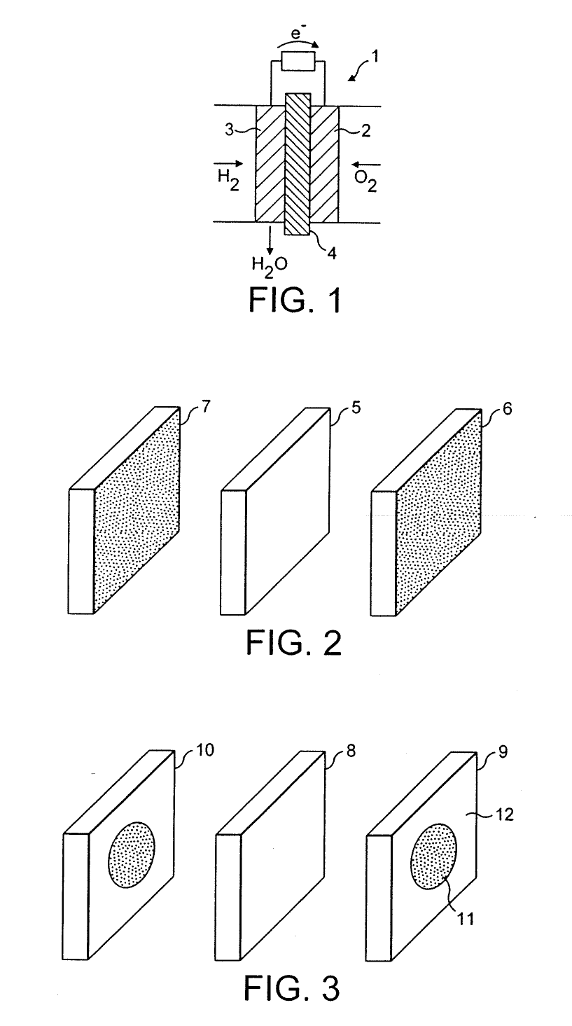

The various embodiments are described herein with reference to the figures. Turning to FIG. 1, a solid oxide fuel cell 1 is shown generally, with a pair of electrodes 2 and 3. Electrode 2 is the cathode (also called the air electrode), and electrode 3 is the anode (also called the fuel electrode). Sandwiched between the electrodes 2 and 3 is a ceramic electrolyte 4 which only permits the transport of oxide anions (O.sub.2.sup.-). Oxygen is delivered to the cathode 2 and hydrogen is delivered to the anode 3. Oxygen is reduced at the cathode 2 (gains electrons) to give oxide anions (O.sub.2.sup.-) which can then travel across the electrolyte 4 to reach the anode 3. At the anode 3, the fuel reacts with the oxide anions to give the exhaust product water (H.sub.2O). Under practical conditions, it is thought that other species may be formed. As a result of the selective ionic permeability of the electrolyte 4, a useful potential is created across the electrodes 2 and 3.

FIG. 2 is an exploded view of certain elements of a fuel cell of the invention. A solid ceramic electrolyte 5 is shown separating a cathode 6 and an anode 7. Although these electrodes and electrolyte are preferably sandwiched together, they are shown spaced apart for clarity. As metals are good thermal and electrical conductors, they have been used in PEM cells. However, they have not been a popular choice in solid state cells because of problems such as mechanical incompatibility with ceramic materials, and failure at high temperature.

The electrodes 6 and 7 are made from titanium. To allow for the transport of the oxidant and fuel through the electrodes 6 and 7 respectively, substantially all of the material comprised in the titanium members 6 and 7 is porous.

The pores in the electrodes 6 and 7 are made in ways known to a person skilled in the art, such as by chemical etching of the titanium foil, or photolithography followed by selective chemical or electrochemical etching. Alternatively, the pores are made by laser machining. The porous region may also be formed by electrodeposition, a technique known in the art.

To allow for the economical construction of the porous electrodes, the electrodes are preferably made from metal foil. Blanks are conveniently cut from a sheet or roll of the metal, for example by laser cutting.

In addition to titanium metal itself, it will be appreciated that suitable titanium alloys can also be used, including commercially available alloys such as Ti-6Al-4V, Ti-3Al-2.5V, Ti-6AL-2Sn-4Zr-2Mo-0.08S-i, and “Timetal 21S®” (Ti-15Mo-3Nb-3Al-0.2Si) sold by the Timet Corporation (Denver, Colo., US) and its global distributors. Either substantially pure metallic titanium or an alloy containing a high proportion of titanium, is suitable. Non-metallic substances (such as ceramic materials or substances containing titanium dioxide rather than metallic titanium), are not considered suitable for use as members or interconnects of the invention.

It will be appreciated that titanium is an extremely strong metal with a high melting point. Thus, the fuel cell may operate at a relatively high temperature without the titanium or titanium alloy member melting. Also, the strength of these metals ensure that the titanium-containing members of the invention can support other structural members of the fuel cell.

Furthermore, the thermal expansion coefficients of titanium and its alloys are suitable for use with a range of ceramics. Matching of the thermal expansion coefficients leads to a reduced tendency to fail under thermal cycling. For example YSZ has a value of 10 to 11.times.10.sup.-6 per .degree. C., whereas bismuth oxide has a value of 24.times.10.sup.-6 per .degree. C. in its cubic form. Bismuth oxide has a very low melting point for a ceramic (825.degree. C.), and its high oxygen ion conductivity is due to a large proportion of vacancies in the oxygen matrix. Aluminium or alloys thereof, for example, make a good thermal expansion match for this ceramic. Aluminium or alloys thereof may be used for the substrates, interconnects and other structures. In certain embodiments, they are used preferably with a protective coating to assist with oxidation resistance.

Oxides have many different crystallographic structures—fluorite and perovskite being among the most common. These different structures can have a wide range of thermal expansion coefficients—in the case of perovskites ranging from about 9 to about 19.times.10.sup.-6 per .degree. C. For certain embodiments contemplated herein, nickel or cobalt alloys, or austenitic stainless steels have compatible thermal expansion coefficients, and are suitable materials to use as substrates, interconnects and for other structures.

One problem of prior art fuel cells is the difficulty in creating an effective seal with ceramic members.

FIG. 3 depicts a view similar to that of FIG. 2, showing an alternative embodiment of electrodes. A ceramic electrolyte 8 is shown separating a cathode 9 and anode 10. The cathode 9 is constructed from titanium foil and has a porous region 11. The cathode 9, however, further comprises a non-porous region 12 which surrounds the porous region 11. Anode 10 is constructed in a similar fashion to cathode 9. The non-porous region 12 of the electrode helps to create a gas-tight seal with other parts of the fuel cell to prevent the unwanted direct combination of oxidant and fuel. The electrodes 9 and 10 are each preferably constructed from an integral sheet of titanium foil of which a portion is treated or machined to become porous.

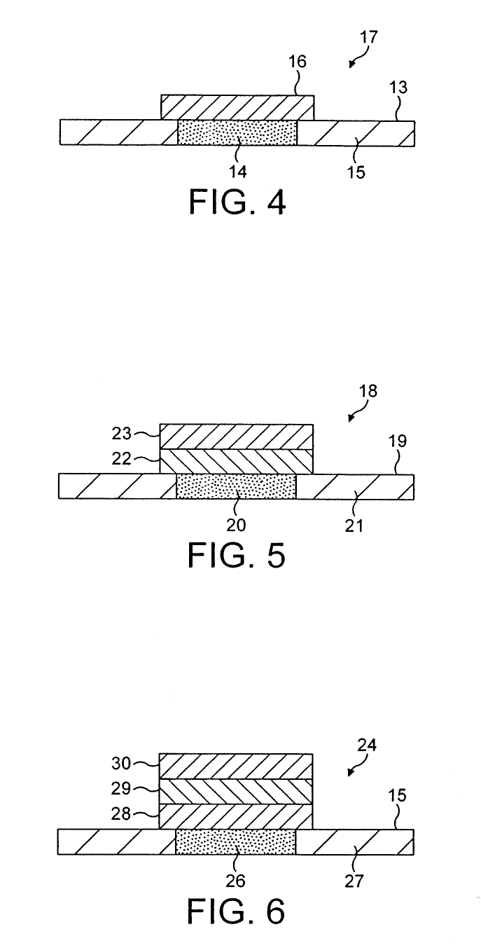

FIG. 4 shows a cross section of a titanium substrate 13 manufactured from titanium foil. The element 13 has a porous region 14 surrounded by a non-porous region 15. The titanium element 13 acts as a substrate that supports an electrolyte layer 16.

Although the electrolyte layer 16 is preferably coated or deposited onto the titanium element 13 directly, it will be appreciated that the electrolyte 16 can be manufactured separately and subsequently located upon the element 13. Advantages of directly manufacturing the electrolyte coating 16 onto the substrate 13 include, but are not limited to, a simple, economical manufacture that achieves a good contact between the electrolyte 16 and the titanium element 13.

Titanium has a melting point of 1816.degree. C., and so a titanium substrate may be heated up to around 1450.degree. C. to facilitate the sintering of a ceramic layer deposited thereon. However, in certain circumstances, titanium and its alloys are susceptible to oxidation, particularly at elevated temperatures. To prevent unwanted oxidation, the titanium-containing member is preferably protected by a coating, for example by a layer of ceramic material such as titanium nitride. A protective coating may conveniently be provided by a layer of ceramic material used as an interface or electrolyte layer. Certain parts of the protective coating may be removed to reveal the surface of the titanium-containing member. Also, sintering may be performed under conditions which reduce or prevent oxidation of the titanium-containing member, such as under an inert atmosphere, for example of argon, or in a vacuum.

The titanium element 13, along with the electrolyte layer 16 is preferably assembled into a fuel cell by, for example, placing an electrode on the upper surface of the electrolyte layer 16. If suitably treated, the titanium element 13 preferably acts as an electrode. In order to function efficiently as an electrode, the surface of the titanium member 13, in particular the porous region 14, is preferably treated or coated to impart beneficial catalytic and/or electrochemical properties. For example, a ceramic material, such as LSCF, is preferably deposited within the pores of the porous region 14 in order to give a practical reaction rate.

It will be appreciated that there are numerous possible embodiments of the use of a porous titanium element as a substrate in a solid-state fuel cell. In particular embodiments, there is more than one layer deposited on the substrate.

FIG. 5 shows a cross-section of a further embodiment of a fuel cell element 18, which comprises a titanium substrate 19 having a porous region 20 and a non-porous region 21 in a similar manner to the element 17 illustrated in FIG. 4. On the upper surface of the titanium element 19 there is preferably a first coating layer 22 that covers the porous area 20 of the substrate 19. In addition, there is preferably a second coating layer 23 on top of the first coating layer 22. The first coating layer 22 may be an interface layer that has properties to enhance the mechanical and/or electrochemical properties of the fuel cell element 18. Alternatively, the first layer 22 may be an electrode itself, with the titanium element 19 acting as a mechanical substrate for the electrode. In this element, the second coating 23 is preferably an electrolyte layer.

The coatings 22 and 23 are preferably ceramic coatings that are deposited directly upon the titanium substrate and sintered thereon. It will be appreciated that ceramic layers can be created on titanium or titanium alloy substrate in many other ways, with or without a sintering step.

FIG. 6 shows a further embodiment of a fuel cell element 24 having a titanium substrate 25 upon which there are three layers of coatings 28, 29 and 30. The titanium element 25 has a porous region 26 bounded by a non-porous region 27. In a preferred embodiment, the first layer 28 is an interface layer between the element 25, which acts as an electrode, and the second coating layer 29, which acts as an electrolyte. Upon the second layer 29 there is an interface layer 30 that is preferably sandwiched against an electrode when assembled in the fuel cell. The titanium member is preferably treated or coated in order to act as an efficient electrode, for example by the presence of catalysts and/or ceramic material within its pores.

Alternatively, the layers 28 and 30 preferably have beneficial properties as electrode layers, with the titanium substrate 25 acting as a mechanical substrate to support the layers 28, 29 and 30.

The porous regions of the titanium substrates preferably allow for the transport of oxidant or fuel through the pores and, for example, into a coating supported thereon. It will be appreciated that the titanium or titanium alloy elements encompassed by various embodiments of the invention may be modified in order to enhance their properties for use in fuel cells. For example, all or part of the surface of the titanium-containing element may be coated to provide, for example, increased chemical resistance. Alternatively, all or part of the titanium-containing element may be treated to enhance its electrochemical properties. For example, the porous region of a titanium-containing element may be doped with other metals or metal salts so that the oxidant or fuel may undergo a more efficient electrochemical reaction at its surface. Furthermore, all or part of the surface of the titanium-containing element may be machined, etched or otherwise treated to have a preferred physical shape, texture, or other surface properties. Such treatment may for example, provide beneficial mechanical, thermal, or other properties.

The titanium-containing element may also be electrodeposited onto a ceramic substrate. This technique can provide both porous and non-porous areas as preferred.

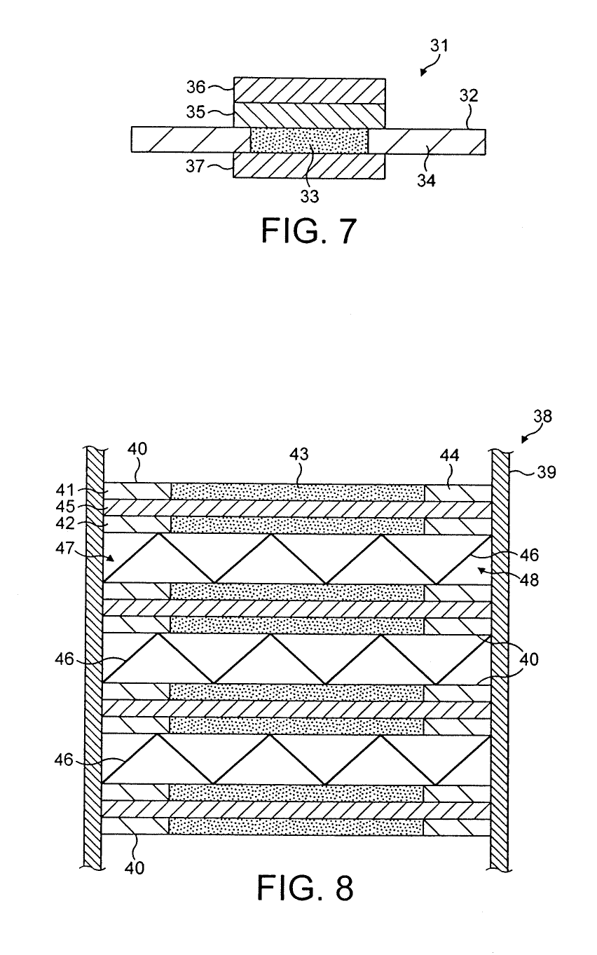

FIG. 7 shows an alternative fuel cell element 31 having a titanium foil substrate 32 supporting three layers 35, 36 and 37. The titanium foil element 32 has a porous region 33 bounded by a non-porous region 34. On one side of the substrate 32 there is provided a layer 35 over the porous region 33. A second layer 36 is located on top of the first layer 35. On the opposite side of the substrate 32 there is located a third layer 37 which again covers the porous region 33. In this embodiment, the first and second layers 35 and 36 act as an interface layer and an electrolyte layer, respectively. The third layer 37, in conjunction with the treated or coated titanium substrate 32, acts as an electrode layer. The coating 37 has beneficial properties which enhance the oxidation of the fuel or the reduction of the oxidant, depending upon which side of the fuel cell the element is to be used. Again, the coating layers 35, 36 and 37 may be deposited directly upon the substrate 32 and sintered thereon in a simple manufacturing process.

To generate a sufficient potential and current from fuel cells, it is common to create a stack of fuel cells electrically connected in series. FIG. 8 shows a schematic illustration of such a stack of fuel cells 38. The fuel cells are contained within walls 39 that provide a gas-tight container for the fuel cell. It will be noted that, for clarity, FIG. 8 does not portend to show features such as oxidant inlets, fuel inlets or exhaust outlets.

Although it is beneficial to stack fuel cells in such a manner, there exist a number of problems with this approach. Firstly, each fuel cell must be provided with oxidant on one side and fuel at the other side. With an operating temperature of several hundred degrees Celsius, the fuel and oxidant must be kept physically separate otherwise explosions or other unwanted direct combustion may take place. Furthermore, the fuel cells generate a significant amount of heat which must be removed in some way. Accordingly, all these factors must be taken into consideration when constructing a stack of fuel cells.

FIG. 8 shows a stack of fuel cell elements 40, each of which comprises a first electrode 41 and a second electrode 42 sandwiched around an electrolyte layer 45. The electrodes 41 and 42 comprise a titanium substrate 41 having a central porous region 43 bounded by a non-porous region 44. Fuel is supplied to one side of the element 40 and oxidant supplied to the other side. FIG. 8 shows a stack of four fuel cell elements 40 separated by corrugated interconnects 46. Each corrugated interconnect 46 is manufactured from titanium or an alloy thereof, preferably by pressing a metal sheet. As described above, substantially pure titanium, or an alloy comprising a majority of titanium, is suitable. The interconnect can also be manufactured by superplastic forming. The corrugated shape of the interconnect allows for the introduction of oxidant 47 and fuel 48 on opposite sides of the interconnect 46. Also, as titanium and its alloys are both thermally and electrically conductive, the interconnect 46 can provide an electrical and thermal connection between adjacent fuel cell elements 40. The interconnect 46 is preferably of a corrugated three-dimensional “egg-box” shape to allow for the efficient supply of fuel and oxidant to the electrodes 41 and 42 of each element 40. The interconnect may be coated on one or both sides to improve resistance to the oxidant and/or fuel.

In a preferred embodiment, the interconnect is positioned between adjacent planar fuel cells in a stack. Preferably, the interconnect serves two main purposes. Firstly, it provides an electrical connection between adjacent fuel cells in a stack of fuel cells. Secondly, it keeps the oxidant supplied to one fuel cell separated from the fuel supplied to the adjacent fuel cell.

In a preferred embodiment the interconnect 46 is connected to the electrode 41, for example by welding. The interconnect 46 is preferably manufactured from a sheet of titanium or titanium alloy thicker than the porous titanium-containing member. This is preferred so the interconnect can withstand stronger forces and harsher conditions than the porous titanium member and provide mechanical support. Also, the use of a thin sheet or foil of titanium preferably allows for the creation of very fine pores to form the porous region, especially where isotropic chemical etching is used to form the pores.

What is claimed:

1. A solid oxide fuel cell comprising an electrode having a porous region bounded by a non-porous region, the electrode comprising at least 51% titanium by weight,
wherein the electrode is a structural member which supports one or more ceramic layers, at least one of the one or more ceramic layers being an electrolyte,
wherein the non-porous region creates a gas-tight seal which prevents direct combination of oxidant and fuel, and
wherein the electrode includes at least one of: (i) other metals or metal salts, (ii) catalysts, and (iii) ceramic material within its pores for improved electrochemical efficiency.

2. A fuel cell according to claim 1 wherein at least one of the one or more ceramic layers comprises cerium gadolinium oxide, yttria stabilised zirconia, nickel oxide/yttria stabilised zirconia cermet nickel oxide/cerium gadolinium oxide cermet, lanthanum strontium cobalt ferrite/cerium gadolinium oxide, doped lanthanum manganate or mixtures thereof.

3. A fuel cell according to claim 1 wherein at least one of the one or more ceramic layers is an interface layer.

4. A fuel cell according to claim 1 further comprising an interconnect comprising titanium or an alloy thereof.

5. A fuel cell according to claim 4 wherein the interconnect is in contact with the electrode.

6. A fuel cell according to claim 1 wherein the porous region comprises sintered metal powder.

7. A fuel cell according to claim 1 wherein the porous region comprises metal felt.

8. A fuel cell according to claim 1 wherein the porous region is formed by laser machining.

9. A fuel cell according to claim 1 wherein the porous region is formed by electrodeposition.

10. A fuel cell according to claim 1 wherein the porous region is formed by etching.

11. A fuel cell according to claim 10 wherein the etching is photochemical etching.

12. A fuel cell according to claim 10 wherein the etching is electrochemical etching.

13. A fuel cell according to claim 4 wherein either the electrode or the interconnect, or both, are formed by pressing.

14. A fuel cell according to claim 4 wherein either the electrode or the interconnect, or both, are formed by superplastic forming.

15. A fuel cell according to claim 4 wherein either the electrode or the interconnect, or both, comprise at least 98% titanium by weight.

16. A fuel cell according to claim 4 wherein either the electrode or the interconnect, or both, comprise at least 85% titanium by weight.

17. A fuel cell according to claim 4 wherein either the electrode or the interconnect, or both, comprise at least 76% titanium by weight.

18. A fuel cell according to claim 4 wherein the interconnect comprises at least 51% titanium by weight.

19. A fuel cell according to claim 4 wherein either the electrode or the interconnect, or both, comprise non-alloyed titanium.

20. A fuel cell according to claim 4 wherein either the electrode or the interconnect, or both, comprise a titanium alloy.

21. A fuel cell according to claim 20 wherein the titanium alloy is Ti-6Al-4V, Ti-3Al-2.5V, Ti-6AL-2Sn-4Zr-2Mo-0.08Si or Ti-15Mo-3Nb-3Al-0.25i.

22. A fuel cell according to claim 4 wherein either the electrode or the interconnect, or both, comprise metal foil.
